(19) United States
(12) Patent Application Publication
(10) Pub. No.: US 2011/0024613 A1
(43) Pub. Date: Feb. 3, 2011

(54) MATERIALS FOR USE AS STRUCTURAL NEUTRON MODERATORS IN WELL LOGGING TOOLS

(75) Inventor: Loren P. Roberts, Humble, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/821,326

(22) Filed: Jun. 23, 2010

Related U.S. Application Data
(60) Provisional application No. 61/221,128, filed on Jun. 29, 2009.

(51) Int. Cl. G01V 5/10; B23P 11/00; B23P 17/00

(52) U.S. Cl. 250/256; 29/428; 29/527.1

(57) ABSTRACT

An instrument for performing measurements downhole, includes: a neutron source; and a neutron moderating material exhibiting high compressive strength and high performance for moderation and shielding of neutrons, the shielding disposed proximate to the neutron source. A method for fabricating the instrument is provided.

### CROSS-REFERENCE TO RELATED APPLICATIONS AND PRIORITY CLAIM

This application claims the benefit of U.S. Provisional Application Ser. No. 61/221,128, entitled “MATERIALS FOR USE AS STRUCTURAL NEUTRON MODERATORS IN WELL LOGGING TOOLS”, filed Jun. 29, 2009, under 35 U.S.C. §119(e), which is incorporated herein by reference in its entirety.

### BACKGROUND OF THE INVENTION

1. Field of the Invention

The invention disclosed herein relates to exploration for oil and gas and, in particular, to structural materials for use in downhole tools that include a neutron source.

2. Description of the Related Art

In the exploration for oil and gas, it is necessary to drill a wellbore into the Earth. While drilling of the wellbore permits individuals and companies to evaluate sub-surface materials and to extract desired hydrocarbons, many problems are encountered.

For example, use of nuclear instrumentation presents significant safety issues for personnel. That is, aside from the burden of complying with regulation governing the handling of sources of ionizing radiation, workers tasked with performing well logging issues are often asked to handle radioactive sources that can cause detrimental health effects if great care is not taken. One example is that of a logging instrument that uses a neutron source. Typically, the neutron source is of a considerable strength. Thus, manufacturers of nuclear instrumentation must incorporate shielding to protect personnel, and to ensure integrity of data signals.

Neutron shielding is most effective when it contains high densities of hydrogen. This provides for effective moderation of neutrons and reduction of neutron energies to levels where they can be efficiently absorbed. Typical materials include polyethylene or polystyrene (polymers). Other moderators include aluminum, beryllium and carbon. Unfortunately, these latter materials are much less effective. Consider that the energy of a neutron can be reduced from 2 MeV to a thermal energy (about 0.025 eV) as a result of one scatter event with a hydrogen nucleus. For the this results in an average of about 20 scatter events for thermalizing a 2 MeV neutron, while carbon requires an average of 192 scatter events, and beryllium an average of 87 scatter events. Therefore, it is desirable to have as high a hydrogen density as possible in a logging tool where neutron shielding is required.

Further, consider that shielding volume is limited in logging tools because such tools must be structurally robust. In wireline implementations, the tool size is small in diameter but must be able to support other logging tools suspended below it. In logging-while-drilling (LWD) implementations, the drill collars are typically much larger in diameter but also contain a mud channel, which limits the volume of structural material available for support of the drill string. Unfortunately, the LWD structural requirements are much higher than wireline because the drilling collars must withstand the drilling operation. Polymers are not typically able to withstand the stresses of the structural materials in these situations. Polymers, polyethylene in particular, can not withstand the maximum temperatures in a logging tool. This creates the need for structural materials also capable of providing effective neutron moderation and shielding.

Therefore, what are needed are materials suited for use in a downhole environment, where the materials provide high performing neutron shielding. The materials should provide high structural strength such that they may be used in structural components of a drill string or wireline logging tool.

### BRIEF SUMMARY OF THE INVENTION

In one embodiment, the invention includes an instrument for performing measurements downhole, the instrument including: a neutron source; and a neutron moderator material exhibiting high compressive strength and high performance for moderation and shielding of neutrons, the moderator disposed proximate to the neutron source.

In another embodiment, the invention includes a method for fabricating a downhole tool including a neutron source, includes: disposing the neutron source in the tool; disposing at least one sensor in the tool; and disposing a neutron shielding material exhibiting high compressive strength and high performance for moderation of neutrons relative to at least one of the neutron source and the at least one sensor.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates an exemplary embodiment of a drill string that includes a logging instrument;

FIG. 2 illustrates an exemplary embodiment for well logging with an instrument deployed by a wireline;

FIG. 3 depicts an exemplary scheme describing the synthesis of the structural neutron moderator;

FIG. 4 depicts a test set-up for evaluation of formulations of the structural neutron moderator;

FIGS. 5 and 6 are graphs providing comparative data for neutron moderation by various materials;

FIG. 7 depicts measured neutron flux for various types of materials;

FIGS. 8A through 8E, collectively referred to herein as FIG. 8, depict an embodiment for use of the structural neutron moderator and various configurations thereof;

FIGS. 9A and 9B, collectively referred to herein as FIG. 9, depict another embodiment for use of the structural neutron moderator deployed in a drill string, where the depiction includes a side view and a cross-sectional view, respectively; and

FIG. 10 depict another embodiment for use of the structural neutron moderator deployed in a wireline logging instrument.

### DETAILED DESCRIPTION OF THE INVENTION

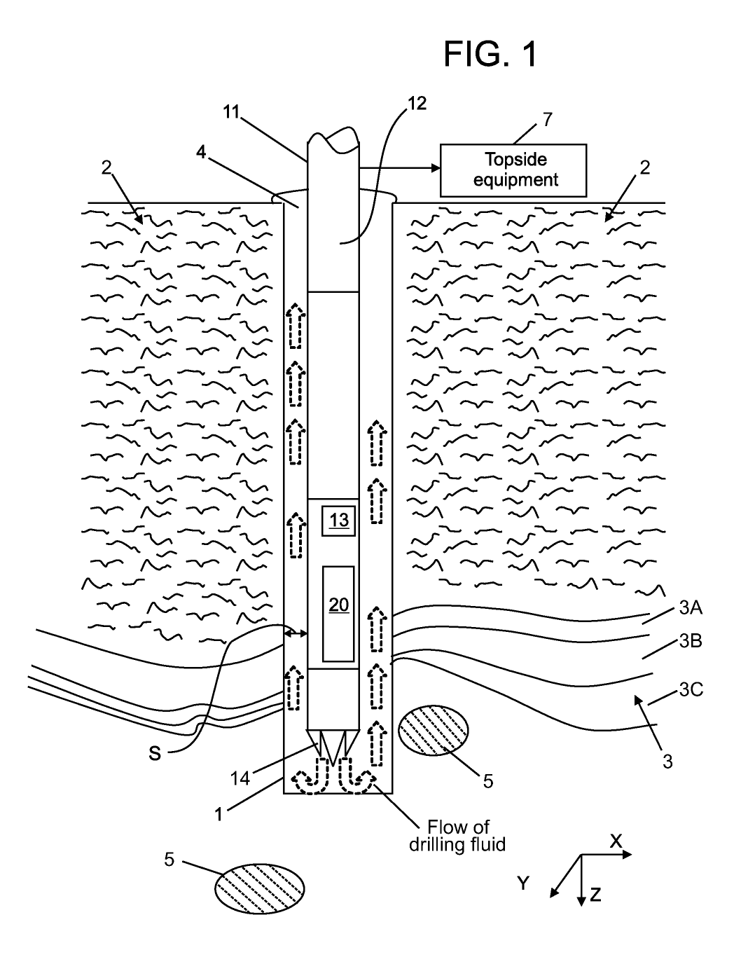

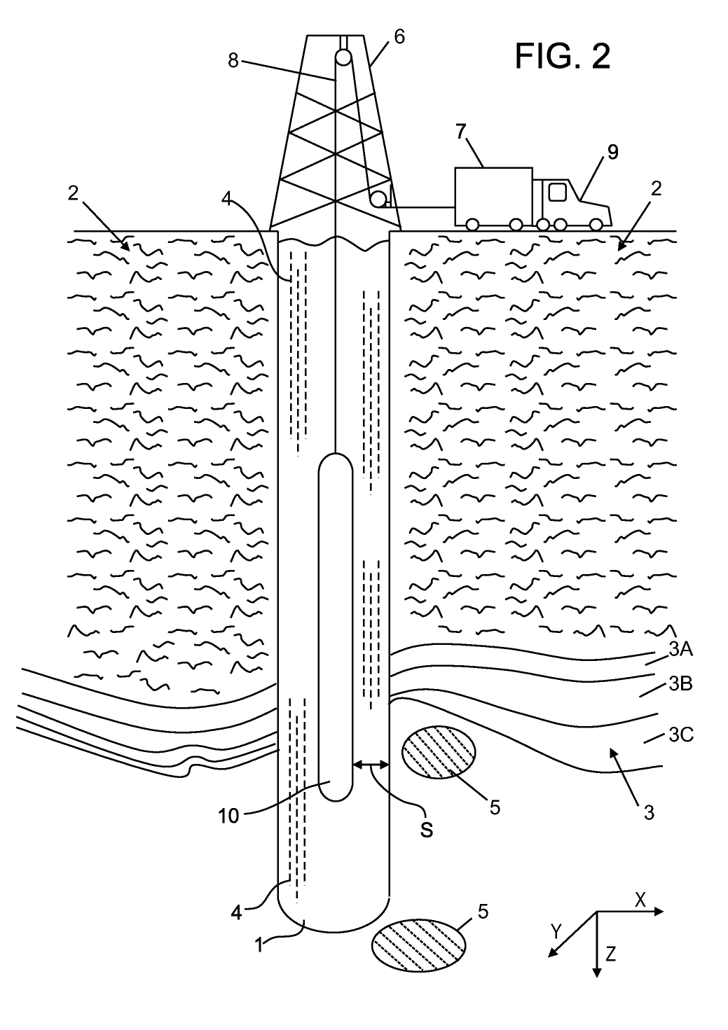

Disclosed are methods, apparatus and compositions for providing structural materials in a downhole instrument, where the materials also provide effective neutron moderation and shielding. For perspective, aspects of equipment where the materials may be used are presented in FIGS. 1 and 2.

Refer now to FIG. 1 where aspects of an apparatus for drilling a wellbore 1 (also referred to as a “borehole”) are shown. As a matter of convention, a depth of the wellbore 1 is described along a Z-axis, while a cross-section is provided on a plane described by an X-axis and a Y-axis.

In this example, the wellbore 1 is drilled into the Earth 2 using a drill string 11 driven by a drilling rig (not shown) which, among other things, provides rotational energy and downward force. The wellbore 1 generally traverses sub-surface materials, which may include various formations 3 (shown as formations 3A, 3B, 3C). One skilled in the art will recognize that the various geologic features as may be encountered in a subsurface environment may be referred to as “formations,” and that the array of materials down the borehole (i.e., downhole) may be referred to as “sub-surface materials.” That is, the formations 3 are formed of sub-surface materials. Accordingly, as used herein, it should be considered that while the term “formation” generally refers to geologic formations, and “sub-surface material,” includes any materials, and may include materials such as fluids, gases, liquids, and the like.

The drill string 11 includes lengths of drill pipe 12 which drive a drill bit 14. In this example, the drill bit 14 also provides a flow of a drilling fluid 4, such as drilling mud. The drilling fluid 4 is often pumped to the drill bit 14 through the drill pipe 12, where the fluid exits into the wellbore 1. This results in an upward flow of drilling fluid 4 within the wellbore 1. The upward flow generally cools the drill string 11 and components thereof, carries away cuttings from the drill bit 14 and prevents blowout of pressurized hydrocarbons 5.

The drilling fluid 4 (also referred to as “drilling mud”) generally includes a mixture of liquids such as water, drilling fluid, mud, oil, gases, and formation fluids as may be indigenous to the surroundings. Although drilling fluid 4 may be introduced for drilling operations, use or the presence of the drilling fluid 4 is neither required for nor necessarily excluded from well logging operations. Generally, a layer of materials will exist between an outer surface of the drill string 11 and a wall of the wellbore 1. This layer is referred to as a “standoff layer,” and includes a thickness, referred to as “standoff, S.”

The drill string 11 generally includes equipment for performing “measuring while drilling” (MWD), also referred to as “logging while drilling” (LWD). Performing MWD or LWD generally calls for operation of a logging instrument 20 that is incorporated into the drill string 11 and designed for operation while drilling. Generally, the MWD logging instrument 20 is coupled to an electronics package which is also on board the drill string 11, and therefore referred to as “downhole electronics 13.” Generally, the downhole electronics 13 provides for at least one of operational control and data analysis. Often, the MWD logging instrument 20 and the downhole electronics 13 are coupled to topside equipment 7. The topside equipment 7 may be included to further control operations, provide greater analysis capabilities as well as data logging and the like. A communications channel (not shown) may provide for communications to the topside equipment 7, and may operate via pulsed mud, wired pipe, and other technologies as are known in the art.

Generally, data from the MWD apparatus provide users with enhanced capabilities. For example, data made available from MWD evolutions may be useful as inputs to geosteering of the drill string 11 and the like.

Referring now to FIG. 2, an exemplary well logging instrument 10 (also referred to as a “tool”) for wireline logging is shown disposed in a wellbore 1 (also referred to as a “borehole”). As a matter of convention, a depth of the wellbore 1 is described along a Z-axis, while a cross-section is provided on a plane described by an X-axis and a Y-axis. Prior to well logging with the logging instrument 10, the wellbore 1 is drilled into the Earth 2 using a drilling rig, such as one shown in FIG. 1.

In some embodiments, the wellbore 1 has been filled, at least to some extent, with drilling fluid 4. The drilling fluid 4 (also referred to as “drilling mud”) generally includes a mixture of liquids such as water, drilling fluid, mud, oil, gases, and formation fluids as may be indigenous to the surroundings. Although drilling fluid 4 may be introduced for drilling operations, use or the presence of the drilling fluid 4 is neither required for nor necessarily excluded from well logging operations. Generally, a layer of materials will exist between an outer surface of the logging instrument 10 and a wall of the wellbore 1. This layer is referred to as a “standoff layer,” and includes a thickness, referred to as “standoff, S.”

The logging instrument 10 is lowered into the wellbore 1 using a wireline 8 deployed by a derrick 6 or similar equipment. Generally, the wireline 8 includes suspension apparatus, such as a load bearing cable, as well as other apparatus. The other apparatus may include a power supply, a communications link (such as wired or optical) and other such equipment. Generally, the wireline 8 is conveyed from a service truck 9 or other similar apparatus (such as a service station, a base station, etc, . . . ). Often, the wireline 8 is coupled to topside equipment 7. The topside equipment 7 may provide power to the logging instrument 10, as well as provide computing and processing capabilities for at least one of control of operations and analysis of data.

Generally, the logging instrument 10 includes apparatus for performing measurements “downhole” or in the wellbore 1. The measurements and other sequences as may be performed using the logging instrument 10 are generally performed to ascertain and qualify a presence of hydrocarbons 5.

Before aspects of the invention are discussed in greater detail, certain additional definitions are provided.

As used herein, the term “gamma radiation detector” relates to instruments that measure the gamma radiation entering the instrument 10, 20. For example, the gamma radiation detector may use a scintillator material that interacts with gamma radiation and produces light photons which are in turn detected by a photomultiplier tube coupled to electronics. Exemplary gamma radiation detectors include, without limitation, sodium iodide (NaI), lanthanum bromides (LaBr), cesium iodide (CsI), bismuth germinate (BGO), thallium iodide (TlI), and other organic crystals, inorganic crystals, plastics, solid state detectors, and combinations thereof.

As used herein, the term “neutron radiation detector” relates to instruments that measure the neutron radiation entering the instrument 10, 20. For example, the neutron radiation detector may use a scintillator or gaseous material that interacts with the neutron radiation and produces secondary ionizing radiation which creates either an electrical current pulse or light photons, depending on detector type. Exemplary neutron radiation detectors include, without limitation, He-3 gas proportional counter, Li-6 scintillator, proton-recoil scintillators, and other organic crystals, inorganic crystals, plastics, solid state detectors, and combinations thereof which contain neutron sensitive material. Detectors are typically designed to be sensitive to certain energy ranges of neutrons, particularly thermal, epithermal, and fast neutrons.

Also as used herein, the term “characterization data” generally makes reference to a radiological profile (e.g., a gamma emission profile) of the instrument. More specifically, the instrument will exhibit certain radiological characteristics. In various embodiments, these characteristics are a result of irradiation with neutrons, and activation of components of the instrument which may ultimately result in emission of gamma rays from the components. Non-limiting embodiments for the generation of characterization data are provided herein.

The term “detector geometry” relates to a configuration of the neutron and gamma radiation detector(s). The detector geometry may include a size and a shape of the detector material and photomultiplier or other type of detector. The term “placement geometry” relates to relative placement of a radiation detector within the logging instrument or in relation to the surrounding volume. The term “logging while drilling” (LWD) relates to measuring parameters from the wellbore 1 while drilling is taking place.

The terms “neutron capture” or “capture” make reference to a kind of nuclear interaction in which a neutron collides with an atomic nucleus and is merged into the nucleus, thus forming a heavier nucleus. As a result, the heavier nucleus enters into a higher energy state. At least some of the energy of the neutron capture interaction is usually lost by emission of gamma rays. Generally, the neutrons are produced with a pulsed neutron source, but chemical sources may be used.

While operating in the subsurface borehole environment, the electronically timed pulsed-neutron source emits neutrons having energy of about 14 MeV. The neutrons are emitted into the ambient formation(s) 4 and the subsurface materials. In about 1-2 μsecs, these fast neutrons promptly interact with the nuclei of the surrounding sub-surface materials and scatter elastically as well as inelastically, ultimately losing their energy. Some of the nuclei of the atoms with which the neutrons interact become energetically excited during the inelastic scattering process, after which they return to the ground state by emitting one or more gamma rays with energies characteristic of the parent isotope. This process results in the measured inelastic spectrum of gamma ray energies, and can only take place if the energy of the incident neutron is sufficient to raise the nucleus of the parent isotope to one or more of its excited energy levels, or bound states.

The neutrons continue their slowing down process until they reach thermal equilibrium with the surrounding medium. Thermal neutrons typically possess energy of about 0.025 eV, and may remain in a diffusion process for up to about 1000 μsec, or slightly more, before being absorbed by the nuclei of the surrounding atoms. This absorption results in new isotopes of the same elements. Upon absorption, the nuclei of these isotopes usually de-excite through emission of one or more gamma rays. As in the case of the inelastic spectrum, these energies carry the fingerprint of the parent isotope and allow each element (i.e., isotope) to be uniquely identified. This absorption process leads to the acquisition of the capture spectrum. The capture spectra and the inelastic spectra for each individual isotope are different.

Embodiments of downhole tools using a pulsed neutron generator usually provide a burst of about 10E4-10E5 fast neutrons. When the neutron flux is averaged over time, this is equivalent to a steady state emission of about 10E8 neutrons/second. For these embodiments, an energy spectrum of the neutrons shows that the neutrons are very close to monoenergetic, and exhibit an initial energy of about 14.2 MeV, while an angular distribution of the neutrons is very close to isotropic. Therefore, neutrons provided by a pulsed neutron generator generally radiate in all directions, and penetrate not only into the formation direction but also into the tool itself. Accordingly, most tools making use of neutron sources include significant shielding for protection of other components.

The terms “inelastic collision,” “neutron inelastic scattering” or “inelastic” make reference to a collision in which an incoming neutron interacts with a target nucleus and causes the nucleus to become excited, thereby releasing a gamma ray before returning to the ground state. In inelastic collisions, the incoming neutron is not merged into the target nucleus, but transfers some of its energy to the target nucleus before that energy is released in the form of a gamma ray.

Various types of interactions involve either absorption or emission of gamma radiation. Predominant types (as a function of increasing energy) include photoelectric effect, Compton scattering and pair production. As a matter of convention, “photoelectric effect” relates to interactions where electrons are emitted from matter after the absorption of a gamma ray. The emitted electrons may be referred to as “photoelectrons.” The photoelectric effect may occur with photons having energy of about a few eV or higher. If a photon has sufficiently high energy, Compton scattering or pair production may occur. Generally, Compton scattering relates to a decrease in energy (increase in wavelength) of a gamma ray photon when the photon interacts with matter. In pair production, higher energy photons may interact with a target and cause an electron and a positron pair to be formed.

Further, it should be noted that a variety of neutron emitting sources are known. Examples include americium-beryllium (AmBe) sources, plutonium-beryllium (PuBe) sources, californium sources (e.g., Cf-252) and others. Therefore, while the teachings herein are generally directed to a pulsed neutron source, it should be recognized that the term “neutron emitting,” “neutron generator,” and the like may be considered with reference to the variety of sources now available or subsequently devised for providing neutrons downhole. The term “thermalize” generally relates a process for reducing the kinetic energy of a neutron to a thermal energy of about 0.025 eV.

The term “structural neutron moderator” and other similar terms generally describe materials that provide improved performance as a neutron moderator, while also providing robust tolerance to stress, strain and other types of mechanical influence. While the structural neutron moderator provides enhanced performance over prior art materials, the actual performance requirements needed for such materials are deemed to be within the province of system designers, manufacturers and users. Accordingly, while a particular formulation of the structural neutron moderator is presented and discussed herein, this formulation is not limiting of the invention.

One type of material that is useful as a structural neutron moderator is an epoxy with neutron moderation performance close to that of polyethylene and capable of being used structurally. This material can be enhanced with neutron absorbers to create various embodiments of neutron shield materials. Two embodiments of this epoxy, C8 and C12, have hydrogen contents by weight of 53.9% and 55.6%, respectively.

The epoxy used as a structural neutron moderator is a new aromatic/aliphatic diamine designed for use in the aerospace industry. The epoxy differs from other compounds in that the hydrogen is not involved with the typical epoxy cross-linking of molecules. Thus, ideal mechanical properties are achieved and reported as compressive strength of 52.5 MPa and compressive modulus of 2.86 GPa. High density polyethylene is reported to have a compressive strength of 18 MPa. It exhibits the lowest dose, second only to polyethylene, indicating that neutrons were moderated effectively by the outer layers of the material. The curing of the epoxy at 177 C indicates the material is suited for withstanding high temperatures, such as those encountered in well logging.

The aromatic/aliphatic diamine (AFDA) was prepared for incorporation into structural epoxy formulations. In the epoxy system, a covalent bond forms between the aromatic portion of the epoxy and the diamine upon heating and curing. The strong covalent aromatic-to-aromatic bond effectively crosslinks the epoxy monomers and results in good mechanical properties. The aliphatic portion of the diamine is covalently attached to the diamine in a pendant fashion and is not involved in the crosslinking network. Aliphatic character is thereby introduced without negatively affecting the mechanical properties. In addition, the aliphatic chains cannot leach out of the system as sometimes happens when hydrogen bearing species are introduced as an additive.

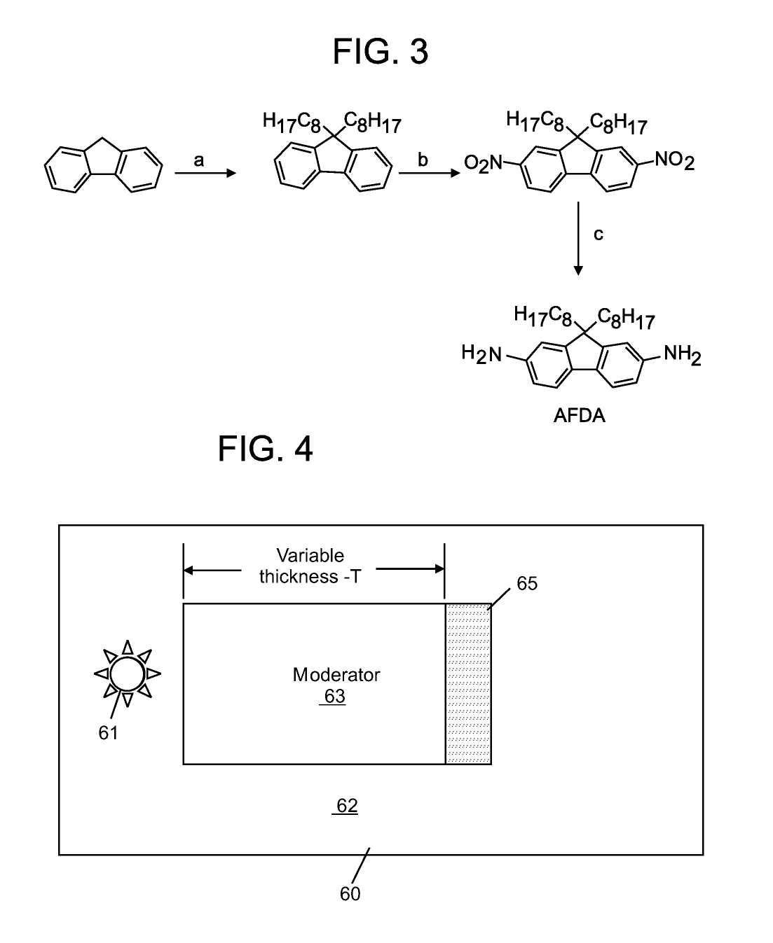

The AFDA was prepared by first alkylating fluorene followed by nitration. The molecule was then reduced to the diamine and used in epoxy formulation. A scheme describing the synthesis is shown in FIG. 3. To formulate the epoxy resin, the diamine was slowly added to TGMDA while heating to 60° C. in a stainless steel mold. The sample was subsequently heated to 80° C. under vacuum and finally placed in a conventional oven and heated to 100° C. for 14 hrs, 120° C. for 1 hr, 140° C. for 1 hr, and 177° C. for 1 hr.

Mechanical testing was performed on the samples to determine their potential as building materials. Compression tests were conducted using a modification of ASTM method D695. Specimens were machined into rectangular prisms of dimensions 4×4×25 mm and the crosshead speed was 1.3 mm/min. Strain was measured using a strain-gauge compressometer (knife-edge clip gauge) with a 5 mm gauge length. Compressive modulus was calculated using the initial linear portion of a stress/strain curve (below 1% strain). The average modulus and apparent compressive strength from four specimens were 2.86±0.19 GPa and 52.5±3.7 MPa, respectively, where the error bounds provided are standard deviations.

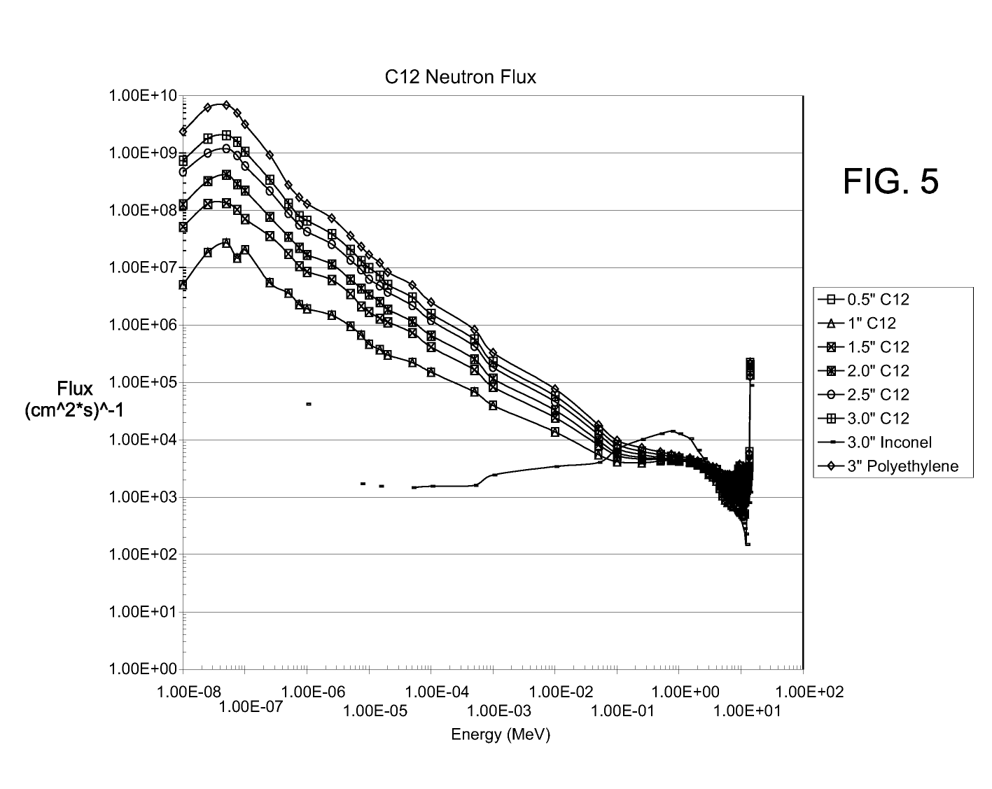

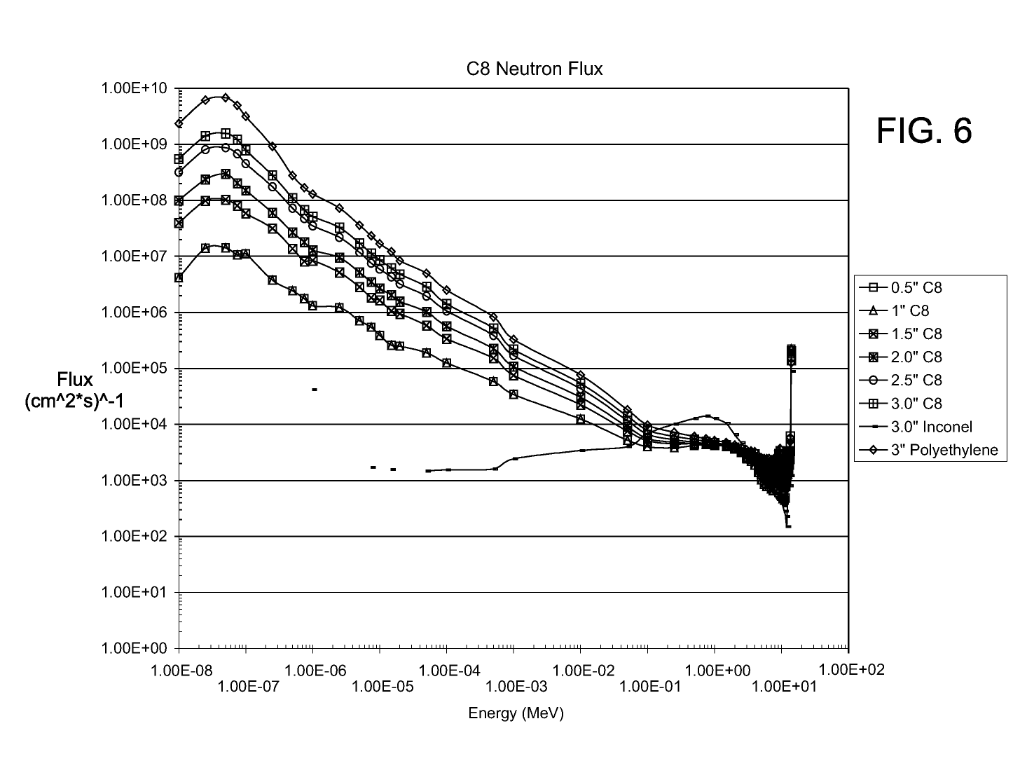

FIG. 4 illustrates aspects of a test setup 60. The test setup 60 was used to qualify aspects of formulations of the structural neutron moderator. In the test setup 60, a block of the structural neutron moderator 63 was placed proximate to a neutron source 61. The neutrons produced were of an energy of about 14 MeV, such as would be encountered with use of a pulsed neutron source downhole. The moderator 63 was surrounded by a vacuum to limit atmospheric interactions. A measurement area 65 was provided to quantify the neutron population after travel through various thicknesses, T, of the moderator 63. Results are provided in FIGS. 5 and 6.

In FIGS. 5 and 6, graphs are provided showing the neutron moderation capability of the C8 and C12 epoxies as compared to three inches of polyethylene and a commonly used alloy known as “Inconel,” which is an austenitic nickel-chromium-based superalloy, that is an oxidation and corrosion resistant material well suited for service in extreme environments. “Inconel” is a registered trademark of Special Metals Corporation.

The data shown was modeled using Monte Carlo modeling techniques in MNCP V1.50. The results of the modeling show that the C8 and the C12 materials are highly efficient at moderating high energy neutrons and approach the performance for moderation of polyethylene. In fact, even half of one inch of material is a large improvement over Inconel, which does not significantly thermalize any neutrons in three inches of material.

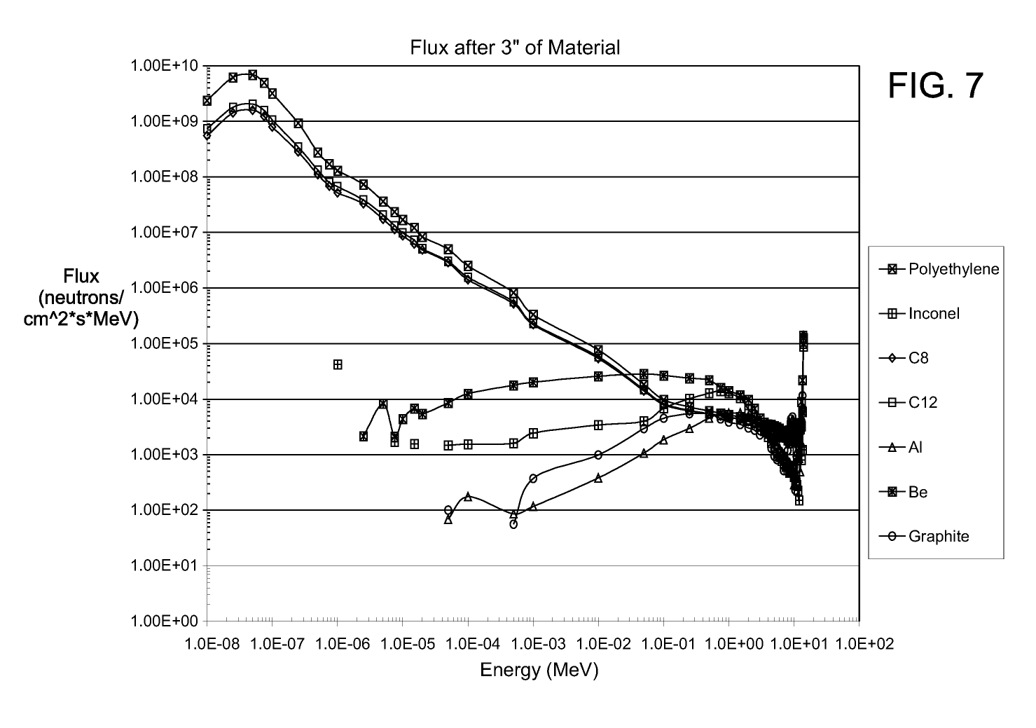

FIG. 7 shows the performance of various materials that are commonly used to scatter neutrons. C8 and C12 far outperform the Al, Be, Inconel, and graphite. The data shows that the structural neutron moderator is the closest performer to polyethylene. The test setup 60 of FIG. 4 was used for this comparison.

Gamma ray detectors are subject to gamma rays produced from inelastic scattering from neutrons of higher energies. In well logging measurements, it is desirable to measure gamma rays originating from the environment surrounding the tool, while limiting interference of gamma rays generated from within the tool body. Use of the structural neutron moderator provides for reducing the energy of neutrons and scattering them out of the tool body. This lowers the number of gamma rays that travel to the vicinity of the gamma ray detectors, and thus lowers the number of inelastic scattering events that produce gamma rays within the tool 10, 20. Further, the number of capture gamma rays produced can be lowered by the addition of a neutron absorbing material to the epoxy.

In some embodiments, it is desirable to produce gamma rays by the neutron capture process, such as for sourceless density measurements. In this case, neutron capture targets are placed in the tool 10, 20 that absorb neutrons and emit characteristic gamma rays. This absorption preferentially takes place with low energy neutrons. The structural neutron moderator can be used to moderate neutrons to lower energies to increase the rate of neutron capture in the target and thus the number of capture gamma rays produced.

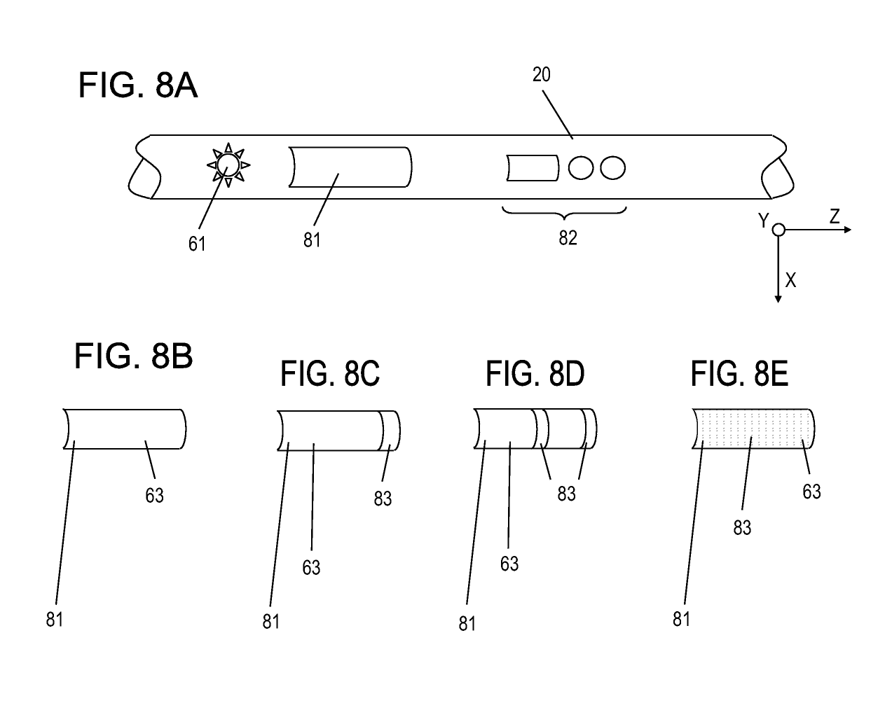

In some embodiments, neutron detectors may be located near gamma ray detectors in a tool. The neutron detectors will require shielding from the moderated neutrons that don't come from the environment surrounding the tool. Neutron detectors are primarily sensitive to low energy neutrons, but can still acquire one third or more of their counts from neutrons above epithermal energies. Thermal and epithermal neutrons are easily shielded by an addition of Cd, B, Gd, and other neutron absorbers to the moderator. It can be placed after the moderator, layered, or mixed in as a powder or small pieces. Reference may be had to FIGS. 8A through 8E, collectively referred to as FIG. 8.

In FIG. 8A, a plurality of detectors 82 are located in an exemplary well logging tool 20. The detectors 82 include various types of detectors, such as gamma detectors and neutron detectors. A neutron shield is disposed between the detectors 82 and the neutron source 61. Various embodiments of the neutron shield 81 are provided in FIGS. 8B through 8E. In FIG. 8B, the neutron shield 81 includes structural neutron moderator 63, provided in a pure form. In FIG. 8C, the neutron shield 81 includes structural neutron moderator 63, with a layer of a neutron absorber 83, such as cadmium. In FIG. 8D, the neutron shield 81 includes structural neutron moderator 63, with interposing layers of a neutron absorber 83, such as cadmium. In FIG. 8D, the neutron shield 81 includes structural neutron moderator 63, with a disbursed mixture of a neutron absorber 83, such as cadmium, disposed and generally evenly mixed therein.

In some embodiments, neutron detectors can have their efficiency raised by using the structural neutron moderator as a reflector. In the prior art, designers place a material such as aluminum, carbon, or beryllium behind a neutron detector to reflect neutrons back into the detector after they have passed through without interaction. This is typically coupled with a neutron absorber behind the reflector to prevent neutrons from coming from undesirable directions (behind the tool). Accordingly, the structural neutron moderator may be used advantageously in such embodiments.

This epoxy can be coupled with neutron absorbers such as cadmium (Cd), gadolinium (Gd), boron (B), and other such materials, to effectively moderate and shield neutrons in logging tools based on its high hydrogen content and structural properties. The structural properties allow larger volumes of the material to be used within the tools due to some of the load being able to be transmitted through the epoxy. Larger volumes result in more effective shields. The epoxy can be used to coat surfaces and fill odd-shaped volumes within a tool.

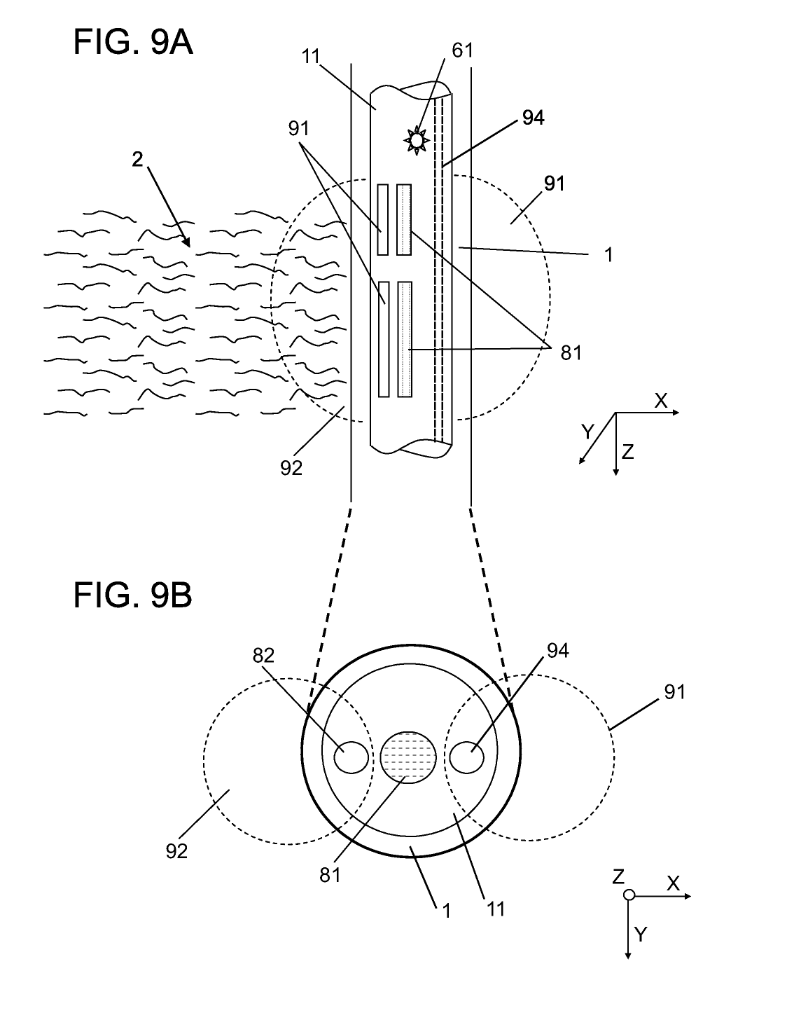

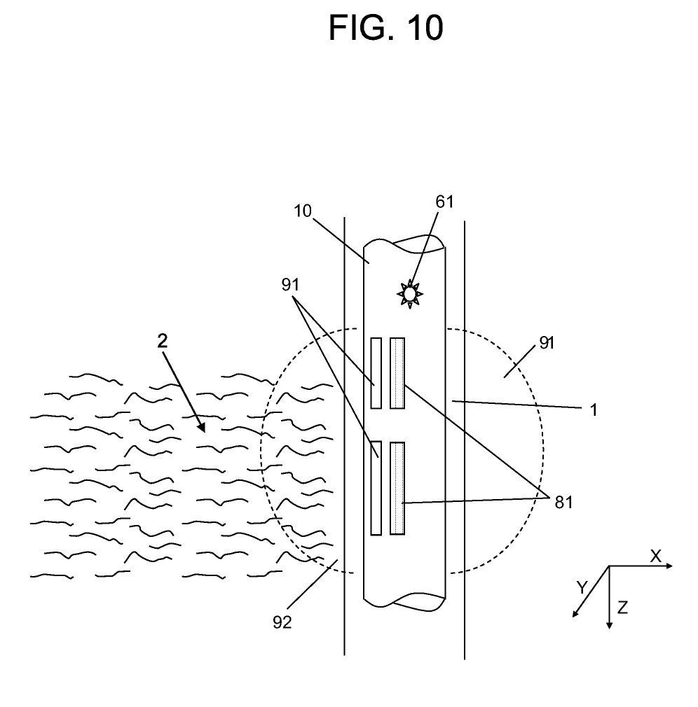

Aspects of some additional and non-limiting embodiments are now discussed. It is well understood that fewer undesired neutrons reaching the detector body in the vicinity of detectors results in increased accuracy of measurements. Thus, a combination of the structural neutron moderator and an absorber material can be used in wireline to moderate neutrons entering a tool from directions other than the formation, as illustrated in FIG. 10. The structural neutron moderator can be used to eliminate and/or reduce borehole effects. Similarly, the structural neutron moderator can be used in LWD applications to shield a detector 91 from neutrons that come from the borehole or mud channel within the collar. One example is shown in FIGS. 9A and 9B, collectively referred to as FIG. 9.

In both LWD and wireline, the structural neutron moderator can serve as a moderator and be coupled with a neutron absorber to help prevent neutrons from traveling directly from the source to detector. In LWD, neutron detectors can be focused in an azimuthal range of angles. This allows for collecting data azimuthally as the tool rotates and creating images from the data.

In additional embodiments, the structural neutron moderator is used in a custom-shaped layered shield and moderator. The structural neutron moderator is layered with an absorber and cured to the final shape. Also, the absorber may be spread throughout the moderator, for instance if a powder is mixed into the epoxy before it hardens. The purpose of this is to absorb lower energy neutrons in stages, which reduces the probability of the neutrons scattering out of the shield before reaching an absorber placed only at the end of the moderator. These neutrons may scatter out of the moderator, then scatter in the surrounding material, and return to the detector. Non standard shapes may be made to fill any available voids within a tool to maximize shielding. These concepts do not limit the possible configurations of this epoxy as a moderator.

Components making use of the structural neutron moderator for incorporation into downhole tooling may be fabricated in a variety of ways. For example, prefabricated components may be fabricated separately from the tool, such as in a mold where the components are then cured, finished and then added to the tool. The components may be fabricated as a part of the tool, such as by pouring, injecting or otherwise placing a portion of pre-cursor compound into the tool, where the tool is then baked or otherwise treated such that the pre-cursor compound is finished and the structural neutron moderator is realized. Examples of such latter embodiments include tools where void spaces are filled with the pre-cursor compound, and one of the last manufacturing stages includes setting of the compound. Accordingly, “jacketing” of some components may be achieved in this manner, among others. Jacketing may be beneficial, for example, to increase the structural security of components surrounded by the structural neutron moderator, as well as by providing neutron shielding for the surrounded components in a manner not previously achievable.

In summary, the teachings herein provide a unique structural neutron moderator for use in a downhole environment. The structural neutron moderator provides high performance neutron moderation while exhibiting robust mechanical strength. Accordingly, designers, manufacturers and users of downhole tooling are provided with lighter weight tooling having better neutron management, and greater capabilities that result from reductions in the volume of neutron shielding provided in traditional systems.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An instrument for performing measurements downhole, the instrument comprising:
a neutron source; and
a neutron moderating material exhibiting high compressive strength and high performance for moderation and shielding of neutrons, the shielding disposed proximate to the neutron source.

2. The instrument as in claim 1, wherein the neutron source comprises at least one of a pulsed neutron generator, an AmBe source, Cf, and an PuBe source.

3. The instrument as in claim 1, wherein the shielding material comprises at least one of an aromatic diamine and an aliphatic diamine.

4. The instrument as in claim 1, wherein the shielding material comprises a cross-linked compound.

5. The instrument as in claim 1, wherein the shielding comprises a neutron absorber.

6. The instrument as in claim 5, wherein the neutron absorber comprises at least one of cadmium, boron, gadolinium and a combination thereof.

7. The instrument as in claim 1, wherein the shielding comprises at least one of a layer of a neutron moderator and a neutron absorber mixed therein.

8. The instrument as in claim 1, wherein the compressive strength is up to about 52.5 MPa.

9. The instrument as in claim 1, wherein the neutron moderating material exhibits a compressive modulus of up to about 2.86 GPa.

10. A method for fabricating a downhole tool comprising a neutron source, the method comprising:
disposing the neutron source in the tool;
disposing at least one sensor in the tool; and
disposing a neutron shielding material exhibiting high compressive strength and high performance for moderation of neutrons relative to at least one of the neutron source and the at least one sensor.

11. The method as in claim 10, wherein the disposing the neutron shielding material comprises at least one of adding a prefabricated component, and placing a pre-cursor compound into the tool.

12. The method as in claim 11, wherein the placing comprises at least one of pouring, injecting and jacketing.

13. The method as in claim 11, further comprising adding at least one neutron absorber to the neutron shielding material.

14. The method as in claim 13, wherein the adding comprises at least one of layering and mixing the neutron absorber.

15. The method as in claim 13, wherein disposing the neutron shielding material comprises establishing an insensitive region for monitoring with the at least one sensor.

16. The method as in claim 11, wherein disposing the neutron shielding material comprises disposing at least one of C8 and C12 epoxy.
